(19) United States
(12) Patent Application Publication
(10) Pub. No.: US 2014/0113020 A1
(43) Pub. Date: Apr. 24, 2014

(54) MOLD MANUFACTURING MASK BLANKS AND METHOD OF MANUFACTURING MOLD

(71) Applicants: Mitsuhiro Kureishi, Tokyo (JP); Shuji Kishimoto, Tokyo (JP); Takashi Sato, Tokyo (JP)

(72) Inventors: Mitsuhiro Kureishi, Tokyo (JP); Shuji Kishimoto, Tokyo (JP); Takashi Sato, Tokyo (JP)

(73) Assignee: HOYA CORPORATION, Shinjuku-ku, Tokyo (JP)

(21) Appl. No.: 14/009,206

(22) PCT Filed: Apr. 6, 2011
(86) PCT No.: PCT/JP2011/058716

§ 371 Date: Oct. 25, 2013

(51) Int. Cl. B29C 33/38

(52) U.S. Cl. CPC B29C 33/38
USPC 425/385; 216/12

(57) ABSTRACT

A fine pattern is formed with high pattern precision, and a time required for fabricating a mold is considerably shortened. Provided are mask blanks used for manufacturing a sub-master mold by transferring the fine pattern provided on a surface of an original mold by imprint, having a hard mask layer including a chromium compound layer expressed by a chemical formula CrOₓN_{y}C_{z} (x>0), on a substrate.

### TECHNICAL FIELD

The present invention relates to mold manufacturing mask blanks, mask blanks with mold manufacturing resist and a method of manufacturing mold, and particularly relates to the method of manufacturing mold from a master mold having a fine pattern and the mask blanks used for manufacturing a mold for imprint.

### DESCRIPTION OF RELATED ART

Conventionally, in a magnetic disc used for a hard disc, etc., a technique of minimizing a magnetic head width, and narrowing a space between data tracks in which information is recorded, to thereby achieve a higher density, has been used. Meanwhile, higher density of the magnetic disc is further in progress, and a magnetic influence between adjacent tracks cannot be ignored. Therefore, in the case of the conventional technique, there is a limit in the higher density.

In recent years, a new type of medium such as a discrete track recording medium (also called a DTR medium) is proposed, in which the data tracks of the magnetic disc are magnetically separated.

The DTR medium is the medium for improving a signal quality by removing (grooving) a magnetic material of a portion not required for recording. Specifically, after grooving, the groove is filled with a non-magnetic material, and a surface flatness of an angstrom level is realized, which is required for a magnetic disc drive. Then, an imprint technique is used as one of the techniques of grooving such a fine width. Note that a new type of medium such as a medium of recording a bit patterned medium (medium for recording a signal as a bit pattern (dot pattern)), has also been proposed, which is the technique regarding a further developed high-dense DTR medium, and the imprint technique is also considered promising in such a pattern formation of the patterned medium.

Note that the imprint technique is roughly divided into two kinds, such as a thermal imprint and an optical imprint. The thermal imprint is a method of pushing a heated mold with a fine pattern formed thereon against a thermoplastic resin being a molded material, thereafter cooling/releasing the molded material, and transferring the fine pattern. Also, the optical imprint is a method of pushing the mold with the fine pattern formed thereon against light-curing resin being the molded material, which is then hardened under irradiation of UV-light, and thereafter releasing the molded material, and transferring the fine pattern.

In the mold for optical imprint given here, the mold used for imprint is called a working mold. Then, in the mold for the optical imprint, usually, a master mold with the fine pattern formed thereon, is not used as the working mold. Instead, a sub-master mold is used as the working mold on which the fine pattern of the master mold is transferred, such as a second-order mold formed by transferring the fine pattern of the master mold on another molded material, and a third-order mold formed by transferring the fine pattern of the second-order mold to another molded material. Even if the sub-master mold is deformed or broken, the sub-master mold can be fabricated if the master mold is safe.

When the above-mentioned DTR medium is actually fabricated, the sub-master mold is required to be fabricated in each fabrication line.

Although there is no direct relation with the fabrication of the sub-master mold for optical imprint, a technique of forming a chromium nitride layer on a light-transmissive substrate such as a quartz glass, coating thereon with a resist, and thereafter forming a resist pattern using an electron beam writing, etc., is disclosed by inventors of the present invention (for example, see patent document 1). In this patent document 1, the fine pattern is formed by applying etching treatment to the chromium nitride layer, with the resist pattern as a mask. Thereafter, the grooving treatment is applied to the light-transmissive substrate with a fine patterned chromium nitride layer as a mask.

### PRIOR ART DOCUMENT

### Patent Document

Patent document 1: Japanese Patent Laid Open Publication No. 2005-345737

### SUMMARY OF THE INVENTION

### Problem to be Solved by the Invention

However, if the working mold is fabricated by electron beam writing applied to the resist, a considerable plotting time is required. For example, when the mold for DTR medium is fabricated, one week is required in some cases for writing the fine pattern. Therefore, there is a problem that a merit of the imprint technique such that the fine pattern can be transferred by a simplified step of pushing the mold, is canceled by a point that the considerable time is required for fabricating the working mold.

Further, when the technique of patent document 1 is applied to the fabrication of the sub-master mold for imprint as it is, the following problem occurs.

Namely, according to the technique of patent document 1, dry etching is performed using chlorine and oxygen, for etching the chromium nitride layer. The etching using the chlorine and oxygen is the etching performed isotropically. Therefore, etching is also applied to a portion not required to be etched in a middle of the etching for forming the fine pattern on the chromium nitride layer. As a result, there is a problem that a variation is generated in a dimension of the fine pattern in the chromium nitride layer.

In order to suppress such a problem, it can be considered that oxygen is not used in the dry etching. However, when the fine pattern is formed on the chromium nitride layer, chromyl chloride is not formed, which is supposed to be volatilized and removed by an etching gas unless the chromium nitride layer is oxidized by oxygen. As a result, it is difficult to perform etching, with a presence of only chlorine as the etching gas.

In this case, it can also be considered that physical etching is performed by enlarging an output of an etching device, using the chlorine gas only as the etching gas. However, by performing the physical etching, it is difficult to set a desired etching selectivity in this case, between a hard mask layer and a resist, or between the hard mask layer and a substrate, resulting in roughness of a substrate surface or deformation of the fine pattern, and so forth.

In view of the above-described circumstance, the present invention is provided, and an object of the present invention is to provide mold manufacturing mask blanks, mask blanks with mold manufacturing resist and a method of manufacturing mold, capable of forming a fine pattern with high pattern precision and considerably shortening a fabrication time required for the mold.

### Solution to the Problem

According to a first aspect of the present invention, there is provided mold manufacturing mask blanks, used for manufacturing a mold by transferring a fine pattern by imprint, which is formed on a surface of an original mold, and having a hard mask layer including a chromium compound layer expressed by a chemical formula CrOₓN_{y}C_{z} (x>0) on a substrate.

According to a second aspect of the present invention, there is provided the mold manufacturing mask blanks of the first aspect, wherein a conductive layer is not provided on the chromium compound layer of the hard mask layer.

According to a third aspect of the present invention, there is provided the mold manufacturing mask blanks of the first or second aspect, wherein the hard mask layer is composed of a chromium oxide layer or an oxide and nitride chromium layer only.

According to a fourth aspect of the present invention, there is provided the mold manufacturing mask blanks of any one of the first to third aspects, wherein the substrate is a light-transmissive substrate.

According to a fifth aspect of the present invention, there is provided the mold manufacturing mask blanks of any one of the first to fourth aspects, wherein the substrate is a quartz substrate.

According to a sixth aspect of the present invention, there is provided the mold manufacturing mask blanks of any one of the first to third aspects, wherein the substrate is silicon carbide or a silicon wafer.

According to a seventh aspect of the present invention, there is provided mask blanks with mold manufacturing resist, wherein a pattern forming resist layer is formed on the hard mask layer in the mold manufacturing mask blanks according to any one of the first to sixth aspects.

According to an eighth aspect of the present invention, there is provided the mask blanks with mold manufacturing resist of the seventh aspect, wherein the resist layer is made of a light-curing resin.

According to a ninth aspect of the present invention, there is provided the mask blanks with mold manufacturing resist of the seventh aspect, wherein the resist layer is made of thermoplastic resin.

According to a tenth aspect of the present invention, there is provided the mask blanks with mold manufacturing resist of any one of the seventh to ninth aspect, wherein a fine pattern transferred to the mask blanks by imprint, is formed by providing a groove on a substrate, and a thickness of the hard mask layer is 2 nm or more and 5 nm or less when a depth of the groove is beyond 0 nm and 80 nm or less.

According to an eleventh aspect of the present invention, there is provided a method of manufacturing a mold from an original mold for imprint with a groove provided thereon corresponding to a fine pattern, including:

forming a hard mask layer including a chromium compound layer expressed by a chemical formula CrOxNyCz (x>0) on a substrate for the mold, and forming a pattern forming resist layer on the hard mask layer;

transferring a fine pattern of the original mold to the resist layer by optical imprint or thermal imprint; and

applying wet-etching to the hard mask layer, with the resist layer to which the fine pattern is transferred, as a mask.

According to a twelfth aspect of the present invention, there is provided a method of manufacturing a mold from an original mold for imprint provided with a groove corresponding to a fine pattern, comprising:

forming a hard mask layer including a chromium compound layer expressed by a chemical formula CrOₓN_{y}C_{z} (x>0) on a substrate for the mold, and forming a pattern forming resist layer on the hard mask layer;

transferring a fine pattern of the original mold to the resist layer by optical imprint or thermal imprint; and

applying dry-etching to the hard mask using a gas including a chlorine-based gas under an atmosphere not including an oxygen gas substantially, with the resist layer as a mask, to which the fine pattern of the original mold is transferred,

wherein, the atmosphere not including the oxygen gas substantially, is the atmosphere that even if the oxygen gas flows into the atmosphere, a flow amount of the oxygen gas allows anisotropic etching to be performed during an etching process, and is the atmosphere in which an oxygen content in the etching device is not zero.

According to a thirteenth aspect of the present invention, there is provided the method of the twelfth aspect, wherein a chlorine gas is used for the dry-etching.

According to a fourteenth aspect of the present invention, there is provided the method of any one of the eleventh to thirteenth aspects, wherein a conductive layer is not provided on the chromium compound layer of the hard mask layer.

According to a fifteenth aspect of the present invention, there is provided the method of any one of the eleventh to fourteenth aspects, wherein the hard mask layer is composed of a chromium oxide layer or an oxide and nitride chromium layer only.

According to a sixteenth aspect of the present invention, there is provided the method of any one of the eleventh to fifteenth aspects, wherein the substrate is a light-transmissive substrate.

According to a seventeenth aspect of the present invention, there is provided the method of any one of the eleventh to sixteenth aspects, wherein the substrate is a quartz substrate.

According to an eighteenth aspect of the present invention, there is provided the method of any one of the eleventh to seventeenth aspects, wherein the resist layer is made of a light-curing resin, and optical imprint is used for transferring the fine pattern to the resist layer.

According to a nineteenth aspect of the present invention, there is provided the method of the eighteenth aspect, wherein when the original mold is formed by a non-light-transmissive substrate, exposure is performed from a transferred substrate side for the mold.

According to a twentieth aspect of the present invention, there is provided the method of any one of the eleventh to fifteenth aspects, wherein the substrate is made of silicon carbide or a silicon wafer.

According to a twenty-first aspect of the present invention, there is provided the method of any one of the eleventh to seventeenth aspects, wherein the resist layer is made of thermoplastic resin, and thermal imprint is used for transferring the fine pattern to the resist layer.

According to a twenty-second aspect of the present invention, there is provided the method of any one of the eleventh to twenty-first aspects, wherein the fine pattern transferred to the mask blanks by imprint, is formed by forming a groove on the substrate, and when a depth of the groove is beyond 0 nm and 80 nm or less, a thickness of the hard mask layer is 2 nm or more and 5 nm or less.

### Effect of the Invention

According to the present invention, a fine pattern can be formed with high pattern precision, and a fabrication time required for a mold can be considerably shortened.

### BRIEF DESCRIPTION OF THE DRAWING

FIG. 1 is a sectional schematic view showing a manufacturing step of a mold according to this embodiment.

FIG. 2 is a sectional schematic view showing the manufacturing step of the mold having a mount base according to another embodiment.

FIG. 3 is a view showing a result of observing the mold obtained by an example, using a scanning electron microscope.

### MODES FOR CARRYING OUT THE INVENTION

Strenuous efforts are made by inventors of the present invention, for a method of shortening a manufacturing step and further not causing a variation in a dimension of a fine pattern, when a sub-master mold is manufactured from a master mold for imprint.

As a result, the inventors of the present invention pay attention to the following point: in fabricating the sub-master mold (also simply called a mold) for a master mold for imprint, not a direct writing to a resist, but an imprint technique is used.

When the sub-master mold is manufactured by the imprint technique, a resist different from an electron beam resist used for fabricating a master mold, is required to be used. For example, when an optical imprint technique is used, a resist made of light-curing resin is required to be used. Such a kind of resist is a low molecular resist in many cases, and in this case, an etching selectivity for applying etching to a hard mask layer is likely to be low, compared with a high molecular resist like an electron beam resist. Namely, although etching is desired to be applied to the hard mask layer only, a resist layer is considerably scraped together with the hard mask layer, and as a result, a fine pattern cannot be formed. The same thing can be said for a case of using the thermal imprint technique.

Therefore, it is found by the inventors of the present invention, that the hard mask layer is easily etched equally to the etching selectivity of the resist. Namely, it is found that the etching applied to the hard mask layer is completed before the resist is scraped so much by etching.

Based on this knowledge, the used hard mask layer is configured to include a chromium compound layer expressed by a chemical formula CrOₓN_{y}C_{z} (x>0), namely the chromium compound layer with at least a part of the layer oxidized into a certain form. Then, it is also found that etching not using a large quantity of oxygen gas can be performed while easily applying etching to the hard mask layer under a circumstance that the sub-master mold is manufactured for the master mold for imprint. As a result, it is found that the resist used for the imprint technique can be sufficiently remained when etching is applied to the hard mask layer, and further anisotropic etching can be suppressed as much as possible.

### Embodiment 1

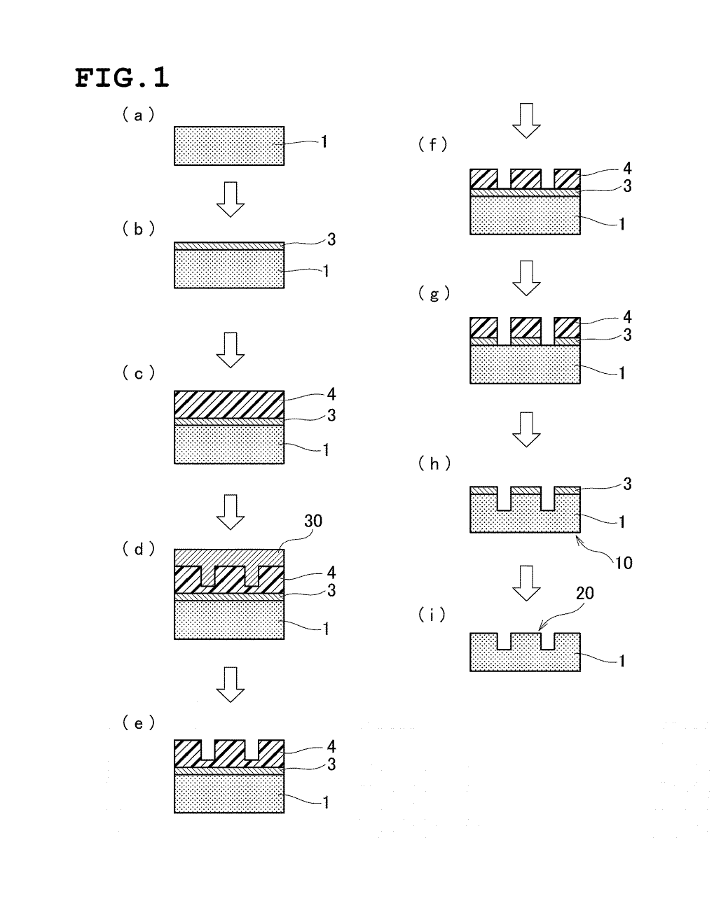

Embodiments of the present invention will be described hereafter, based on FIG. 1.

FIG. 1 is a view showing a method of manufacturing a sub-master mold 20 by optical imprint according to embodiment 1.

First, as shown in FIG. 1(a), a substrate 1 for the sub-master mold 20 is prepared. The substrate 1 may be a conventional one if it can be used as the sub-master mold 20. However, when the optical imprint is performed, it is preferably a light-transmissive substrate from a viewpoint of a light irradiation to a transferred material when the optical imprint is performed. A glass substrate such as a quartz substrate can be given as the light-transmissive substrate. Note that if the master mold (or a working mold being an original mold) in which the fine pattern is formed, has light transmissivity, the substrate 1 may be a non-light-transmissive substrate such as Si substrate.

Further, a shape of the substrate 1 is preferably a disc shape. This is because the substrate 1 can be uniformly coated with resist while being rotated, when it is coated with resist. Note that the shape other than the disc shape such as a rectangular shape, polygonal shape, or semi-circular shape is also acceptable.

In this embodiment, a disc-shaped quartz substrate 1 is used for explanation.

Next, in this embodiment, as shown in FIG. 1(b), the hard mask layer including a chromium compound layer 3 expressed by the chemical formula CrO₂N_{y}C_{z} (x>0) is provided on the substrate 1, as a mask for forming a groove on the substrate 1, corresponding to the fine pattern.

Specifically, in this embodiment, sputtering is performed by a mixed gas of argon and nitrogen, using a chromium target as a sputtering target, to thereby form a chromium nitride layer on the substrate 1, and thereafter baking treatment is applied thereto. Thus, a chromium compound layer being a hard mask layer composed of the chromium compound layer 3 only (namely a chromium compound layer 3 in which x>0 and y>0) is provided on the substrate 1. Thus, the mask blanks according to this embodiment is formed.

As such a chromium compound layer 3, a chromium oxide (CrO) layer, an oxide and nitride chromium layer (CrON) layer, and a chromium carbide compound layer, etc., can be given. However, in the chemical formula CrOₓN_{y}C_{z} of the chromium compound, x>0 is required. This is because if even a part of chromium is not oxidized, chromium chloride (CrO₂Cl₂) described later cannot be generated, and the dry-etching cannot be smoothly performed. Further, a layer made of a mixture of chromium oxide, oxide and nitride chromium, and chromium carbide compound, etc., or a plurality of layers composed of each substance, may be provided as the hard mask layer. In this embodiment, explanation is given for a case that the oxide and nitride chromium layer only is used as the chromium compound layer 3.

Note that the oxide and nitride chromium layer may be formed by sputtering a chromium target by a mixed gas of argon, oxygen, and nitrogen so that the compound being the oxide and nitride chromium originally is formed into a layered state, or by oxidizing the chromium nitride by applying baking treatment thereto as described above.

In this case, in the hard mask layer, the conductive layer is preferably not provided on the chromium compound layer. This embodiment shows a case that the sub-master mold is manufactured as the working mold which does not require a direct writing by electron beams, etc., unlike the case that the master mold is fabricated by applying direct writing to the resist by electron beams, etc. Therefore, it is not necessary to consider a charge-up phenomenon which affects the precision of the pattern during direct writing. As a result, the conductive layer for preventing the charge-up is not required to be provided on the chromium compound layer. Thus, the thickness of the hard mask layer can be small, and in addition, wet-etching described later can be performed, an etching step can be simplified, and a facility cost for the etching step can be reduced. In this embodiment, explanation is given for a case of using the hard mask layer composed of the oxide and nitride chromium layer 3 only, without providing a new conductive layer on the oxide and nitride chromium layer 3.

Note that the “hard mask layer” in this embodiment indicates a layered body composed of a single layer or a plurality of layers, used as a mask for forming a groove on the substrate by etching.

Not only the oxide and nitride chromium layer but also an adhesive layer may also be separately provided on the hard mask layer, other than the conductive layer.

The hard mask layer is thus provided on the substrate, and the layered body is called imprint blanks (or simply called blanks) in this embodiment.

Further, the fine pattern transferred to the mask blanks by imprint, is formed from the groove, and when the depth of the groove is beyond 0 nm and 80 nm or less, the thickness of the hard mask layer is preferably 2 nm or more and 5 nm or less.

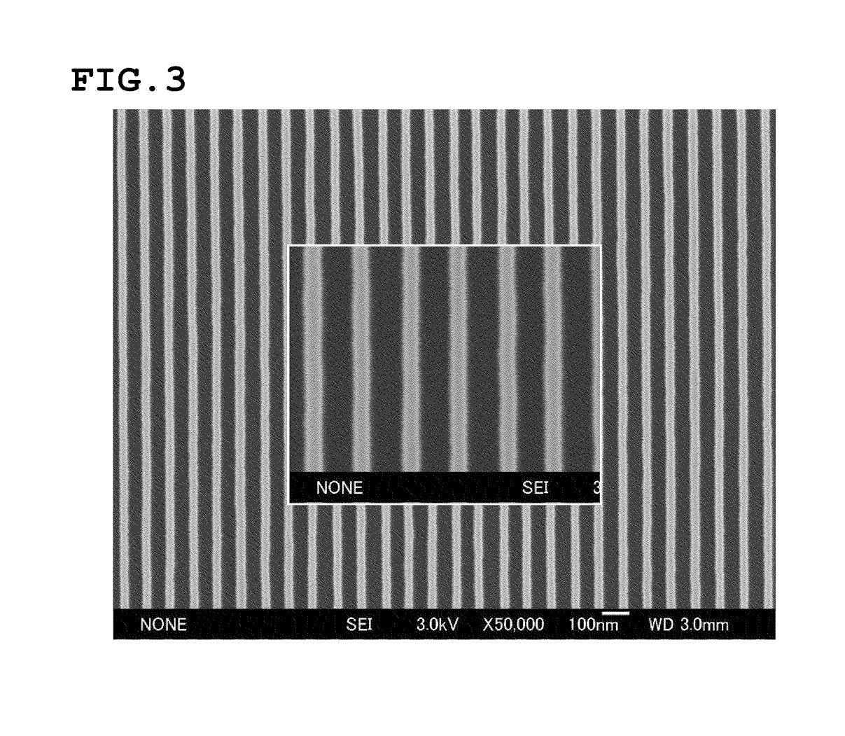

As shown in FIG. 3 described later (example), when the depth of the groove is beyond 0 nm and 80 nm or less, the pattern can be formed over the hard mask layer with a specific pattern precision, if the thickness of the hard mask layer is 2 nm or more. Further, if the hard mask layer has the thickness of 2 nm or more, the following risk can be suppressed, namely the risk of scraping an edge of a portion (protruding portion) other than the groove of the substrate 1 by scraping the hard mask layer when etching is applied to the substrate 1. As a result, the sub-master mold with high contrast performance can be manufactured.

Further, when the depth of the groove is beyond 0 nm and 80 nm or less, the chromium nitride layer can be changed to the oxide and nitride chromium layer by baking, so that the dry-etching can be performed using the chlorine-based gas. Further, considerable time is not required for the etching.

The depth of the groove described here, is the depth of the groove provided on the substrate 1. However, the depth is approximately the same as the depth of the groove of the original mold 30.

Further, the thickness of the hard mask layer is determined by an X-ray reflectometer. Specifically, Kα ray of Cu as an X-ray source is incident on the hard mask layer at a low angle of 0 degree to 7 degrees, to thereby measure an angle dependency of the reflectivity. The hard mask thickness is obtained from the optimized model compared and fitted with one of a CrN single layer model and a CrON/CrN multiple layers model on the quartz substrate, using a film thickness, density, and interface roughness as structural parameters.

After suitably performing cleaning/baking treatment to the hard mask layer of the mask blanks, as shown in FIG. 1(c), a resist layer 4 is formed by coating on the hard mask layer of the mask blanks with resist for optical imprint, to thereby fabricate the mask blanks with resist of this embodiment, which is used for manufacturing the sub-master mold 20 for imprint. Light-curing resin, and particularly UV-ray curing resin can be given as the resist for optical imprint. The resins suitable for the etching applied later among the light-curing resins are acceptable. Note that the light-curing resin is preferably in a liquid state. The reason is as follows: as described later, when the master mold having the fine pattern (or working mold which is an original mold, and these molds are collectively called an original mold 30) is placed on the resist, the resist is easily deformed corresponding to the fine pattern of the original mold 30, and the fine pattern can be transferred with high pattern precision by exposure performed later.

Further, the thickness of the resist layer 4 in this case is preferably the thickness allowing the resist of a portion being a mask to be remained until completion of the etching applied to the oxide and nitride chromium layer 3. This is because when removing the oxide and nitride chromium layer 3 of a portion where the groove is formed on the substrate 1, the oxide and nitride chromium layer 3 of this portion is removed, and a considerable part of the resist layer 4 is also removed.

After baking treatment is applied to the resist layer 4, as shown in FIG. 1(d), the original mold 30 having the fine pattern, is disposed on the resist layer 4. In this case, it is sufficient to dispose the original mold on the resist layer 4, if the resist layer 4 is in the liquid state. Further, when the resist layer 4 has a solid shape, the resist layer 4 is preferably soft so that the fine pattern can be transferred thereto by pushing the original mold 30 against the resist layer 4.

Thereafter, the fine pattern shape is fixed to the resist by curing the light-curing resin using a UV-ray irradiation device. In this case, it is normal that irradiation of the UV-ray is performed from the original mold 30 side. However, when the substrate 1 of the mask blanks is the light-transmissive substrate, the irradiation may be performed from the substrate 1 side. The fine pattern may be a micron-order, or may be a nano-order from a viewpoint of the performance of electronic equipment in recent years, and the nano-order is preferable in consideration of the performance of a final product.

Note that in this case, in order to prevent a transfer failure due to a positional deviation between the original mold 30 and the mask blanks, the groove for an alignment mark may be prepared on the substrate. Specifically, when exposure is performed for transferring the fine pattern, a mask aligner is provided on the resist. By performing exposure from above the mask aligner, a resist pattern with resist of an alignment mark portion removed, can be formed.

After transfer of the fine pattern, as shown in FIG. 1(e), the original mold 30 is removed from the mask blanks, and the pattern of the original mold 30 is transferred to the resist on the mask blanks. Although the transferred resist pattern has a remained film not required for etching the hard mask layer, the remained film is removed by ashing using plasma of a gas such as oxygen, ozone, etc. Thus, as shown in FIG. 1(f), the resist pattern corresponding to a desired fine pattern, is formed. Note that the groove is formed on the substrate 1 at a portion where the resist is not formed.

(First Etching)

Next, the substrate 1 with the resist pattern formed on the substrate, is introduced to a dry-etching device. Usually, not the oxide and nitride chromium layer 3 but the chromium nitride layer is provided, it is difficult to perform first etching using only the chlorine-based gas in the atmosphere of non-presence of oxygen. Therefore, the isotropic etching using chlorine gas and oxygen gas is required to be performed.

However, in the step of applying etching to the hard mask layer of this embodiment, first etching is performed to the substrate on which only the oxide and nitride chromium layer 3 is provided, using the gas including the chlorine-based gas in the atmosphere not including the oxygen gas substantially. The first etching will be described in detail hereafter.

First, the substrate 1 with the resist pattern formed thereon, is introduced to the dry-etching device. In this embodiment, the first etching is performed using the gas including the chlorine-based gas under the atmosphere not including the oxygen gas substantially.

In the dry-etching, chromyl chloride is generated, which has volatility by a reaction between chromium oxide and the chlorine-based gas. Then, by the volatilization of the chromyl chloride, the oxide and nitride chromium layer 3 is etched. Thus, the oxide and nitride chromium layer 3 having a desired pattern can be obtained.

Note that “in the atmosphere not including the oxygen gas substantially” means “the atmosphere that even if the oxygen gas flows into the atmosphere, a flow amount of the oxygen gas is the amount that allows the anisotropic etching to be performed during etching”, and is preferably the atmosphere in a case that the flow amount of the oxygen gas is 5% or less of the whole body of the flowed gas.

However, usually the oxide and nitride chromium layer 3 allows Cr₂O₃ to be formed, without forming chromyl chloride (CrO₂Cl₂). In order to change the Cr₂O₃ to chromyl chloride (CrO₂Cl₂), a slight amount of oxygen is required. Therefore, in this embodiment, the dry-etching is not performed under complete non-presence of the oxygen. Therefore, “the atmosphere not including the oxygen gas substantially” means “the atmosphere in which oxygen content in the etching device is not 0” in addition to the above case.

Here, the chlorine gas can be used as a process gas, and a gas obtained by adding rare gases (He, Ar, Xe, etc.) to the chlorine gas can be used as an addition gas. Further, by using the chlorine-based gas not containing oxygen substantially in the first etching, the anisotropic etching can be performed. By performing the anisotropic etching, the variation in the dimension of the fine pattern can be suppressed, and etching with high pattern precision can be performed.

In this embodiment, explanation is given for a case of introducing the chlorine gas only.

Thus, as shown in FIG. 1(g), the hard mask layer having the fine pattern is formed. Note that an endpoint of the etching in this case, is judged by using an end point detector of a reflective optical system.

(Second Etching)

Subsequently, after the gas used for the first etching is vacuum-exhausted, second etching using a fluorine-based gas is applied to the quartz substrate 1 in the dry-etching device. At this time, etching is applied to the quartz substrate 1 with the hard mask layer as a mask, and as shown in FIG. 1(h), the groove corresponding to the fine pattern is formed on the substrate 1. Note that when the alignment mark is applied, the groove for the alignment mark is also formed on the substrate 1.

As the fluorine-based gas used here, CₓF_{y} (for example CF₄, C₂F₆, C₃F₈), CHF₃, and a mixed gas of them, or an addition gas obtained by adding rare gases (He, Ar, Xe, etc.) to them, can be given.

Thus, as shown in FIG. 1(h), the grooving corresponding to the fine pattern is applied to the quartz substrate 1, and the hard mask layer having the fine pattern is formed on the portion other than the groove on the quartz substrate 1, to thereby remove the resist using an acid solution such as a sulfuric acid/hydrogen peroxide solution. Thus, a mold 10 before removing the remained hard mask layer is fabricated.

(Removal of the Hard Mask Layer)

In the removal of the hard mask layer of this embodiment, wet-etching is performed. First, the mold 10 before removing the remained hard mask layer after removing the resist is introduced to the wet etching device. Then, wet-etching is performed by a di-ammonium cerium(IV) nitrate solution. In this case, a mixed solution of the di-ammonium cerium(IV) nitrate solution and perchloric acid may be used. Note that even in a case of the solution other than the di-ammonium cerium(IV) nitrate solution, the solution capable of removing the oxide and nitride chromium layer can be used.

If the wet-etching is used like this embodiment, the wet-etching with relatively easy operation and relatively simple facility, can be used. As a result, a product yield can be improved because a complicated operation is not required, and the processing can be performed without using an expensive vacuum-processing device, and therefore a facility cost can be reduced.

Note that similarly to the removal of the hard mask layer, the wet-etching may be used instead of the dry-etching in the first and second etching. Specifically, in the first etching, the mixed solution of the di-ammonium cerium(IV) nitrate solution and the perchloric acid may be used similarly to the removal of the hard mask layer. Further, in the second etching, when the substrate is made of quartz, the wet-etching using hydrofluoric acid may be performed.

Meanwhile, in the removal of the hard mask layer, not the wet-etching but the dry-etching may be performed. A basic procedure of the dry-etching of removing the hard mask layer, the gas for the dry-etching, and a mechanism of a progress of the dry-etching is the same as those of the above-mentioned first etching (dry-etching).

Note that the wet-etching may be performed for either one of the etching like this embodiment, and the dry-etching may be performed for another etching, or the wet-etching or the dry-etching may be performed for all etchings. Further, the wet-etching may be introduced according to the pattern size, in such a way that the wet-etching is performed in the stage of the micron-order, and the dry-etching may be performed in the stage of the nano-order.

After the hard mask layer of the portion other than the groove formation portion is removed through the above-mentioned step, cleaning, etc., of the substrate 1 is performed as needed. Thus, the sub-master mold 20 as shown in FIG. 1(i) is completed.

The above-mentioned steps are performed in this embodiment. However, the etching may be added separately between the above-mentioned steps, according to a constitutional substance of the mask blanks.

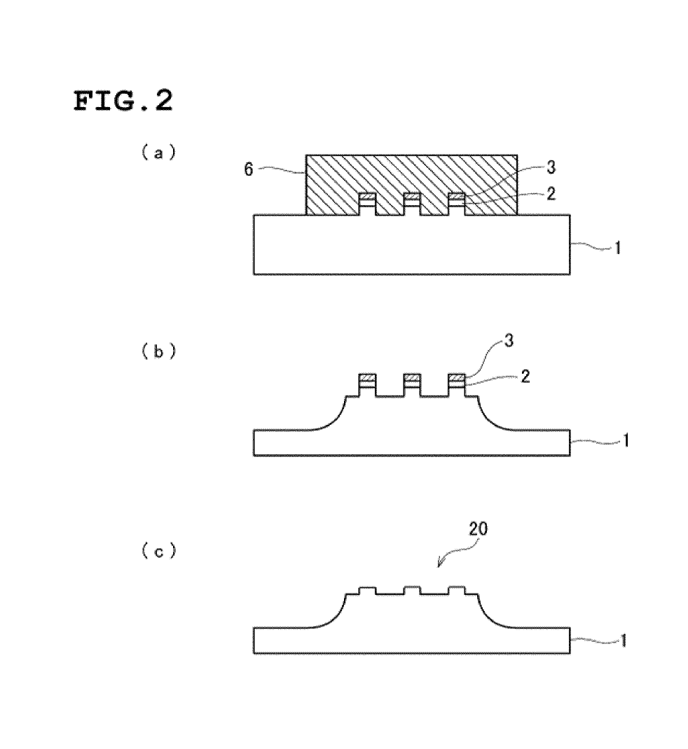

Further, as shown in FIG. 2, if the sub-master mold 20 for imprint is formed into a mount base structure, the following step may be performed before the blanks for the sub-master mold 20 is fabricated.

Namely, the mold 10 before removing the remained hard mask layer with grooving treatment applied to the quartz, is coated with resist 6 for the mount base, and the exposure by UV-ray and development are performed (FIG. 2(a)). Note that when the alignment mark is formed on the substrate 1, the surface of the alignment mark is also coated with the resist 6 for the mount base.

Then, the wet-etching is applied to the mold 10 before removing the remained hard mask layer having the above-mentioned resist pattern, in a mixed solution of hydrofluoric acid and ammonium fluoride, and the resist is further removed by specific acid cleaning (FIG. 2(b)). Thus, the mold 10 before removing the remained hard mask layer having the mount base structure is fabricated (FIG. 2(c)), and the sub-master mold 20 may be fabricated through the wet etching or the dry-etching.

As described above, by forming the sub-master mold 20 for imprint into the mount base structure, a contact area between the sub-master mold 20 and the medium to which the pattern is transferred, is reduced. Further, by the mount base structure, a gap is formed between the sub-master mold 20 and a medium to which the pattern is transferred. By enter of the atmosphere into this gap, or by insertion of a release aiding jig from this gap, releasability between the sub-master mold 20 and the transfer medium to which the pattern is transferred, can be improved.

In this embodiment as described above, the following effect can be obtained.

First, the working mold is not fabricated by direct electron beam writing, but the fine pattern of the original mold 30 is transferred to the mask blanks for manufacturing the sub-master mold 20 by optical imprint. Therefore, the time required for manufacturing the sub-master mold 20 can be considerably shortened.

Further, the hard mask layer includes the chromium compound layer expressed by the chemical formula CrOₓN_{y}C_{z} (x>0). Therefore, the etching applied to the hard mask layer can be facilitated under a circumstance that the sub-master mold for the master mold for imprint is manufactured. Further, the dry-etching can be performed using the chlorine-based gas under the atmosphere not including oxygen substantially. Therefore, the anisotropic etching can be performed. As a result, the dry-etching can be smoothly performed to the hard mask layer with high pattern precision. Consequently, the groove corresponding to the fine pattern can be formed with high pattern precision, and the sub-master mold having excellent quality can be efficiently provided.

In addition, there is no necessity for providing the conductive layer in the mask blanks for manufacturing the sub-master mold 20 for the master mold for imprint. Therefore, the thickness of the hard mask layer itself can be small. Therefore, the resist layer 4 can also be made thin, and a shadowing effect of reducing the fine pattern precision due to the thickness of the resist, can be suppressed. Further, by decreasing an aspect ratio (thickness of a resist remained portion)/(width of the resist remained portion))), collapse of the resist can be prevented.

Further, the hard mask layer not containing the conductive layer is used, and therefore the time required for the etching step applied to the hard mask layer can be shortened.

Further, the conductive layer is not provided on the chromium compound layer in the hard mask layer. Therefore, relatively easily operable wet-etching having a relatively simple facility, can be used. As a result, product yield can be improved because a complicated operation is not required, and further a facility cost can be reduced because an expensive vacuum processing device is not used.

Further, even in a case of the dry-etching, it is sufficient to use a simple dry-etching using the chlorine-based gas without using a gas in consideration of the conductive layer. Moreover, the target for sputtering for providing the conductive layer is not required, thus contributing to the reduction of the cost.

It is also acceptable that using the above-mentioned sub-master mold as the working mold (original mold), a new sub-master mold is separately copied by thermal imprint, or is separately copied by optical imprint, as needed. Further, this embodiment can be applied not only to an imprint technique of micro-order, but also to an imprint technique of nano-order. Particularly, this embodiment can be suitably applied to a DTR medium fabricated using the imprint technique.

### Embodiment 2

In the embodiment 1 described above, explanation is given for the sub-master mold 20 for the master mold for optical imprint.

Meanwhile, in embodiment 2, explanation is given for the sub-master mold 20 for the master mold for thermal imprint. Note that regarding a portion not mentioned specifically, content of this portion is the same as embodiment 1.

First, SiC substrate having a resistance to the chlorine gas used for the dry etching applied to the hard mask layer, can be given as the substrate used for manufacturing the sub-master mold 20 for the master mold for thermal imprint.

In addition to SiC substrate having a resistance to the chlorine-based gas, a silicon wafer having a relatively weak resistance to the chlorine-based gas can be used as the substrate 1 to which the thermal imprint is performed, in such a way that SiO₂ layer is provided first on a silicon wafer 1, and the oxide and nitride chromium layer 3 is provided on the SiO₂ layer, so that the silicon wafer 1 is protected from the chlorine gas by the SiO₂ layer, even if the oxide and nitride chromium layer 3 is removed by the chlorine gas. Then, the SiO₂ layer is removed by buffered hydrofluoric acid (also called BHF hereafter) namely mixed acid of ammonium fluoride and hydrofluoric acid. Thus, the silicon wafer can also be used for fabricating the mold for thermal imprint. Further, the SiO₂ layer can also be provided on the silicon wafer as a processing layer, which can be used as the substrate. In this case, since the groove is provided in the SiO₂ layer being the processing layer, the thickness of the SiO₂ layer is larger than a case that the silicon wafer 1 is used.

In this embodiment, a disc-shaped SiC substrate is used for explanation.

Similarly to embodiment 1, in this embodiment, sputtering is performed by the mixed gas of argon and nitrogen, using a chromium target as a sputtering target, to thereby form the chromium nitride layer on the substrate 1 followed by the baking treatment. Thus, the hard mask layer composed of the oxide and nitride chromium layer 3 only, is provided on the substrate 1. Thus, the mask blanks of this embodiment are formed.

Next, the hard mask layer in the mask blanks is coated with resist for thermal imprint, to thereby form the resist layer 4 and fabricate the mask blanks with resist used for manufacturing the sub-master mold 20 for imprint. Resin (thermoplastic resin) which is cured by cooling can be given as the resist for thermal imprint. The resins suitable for the etching applied later among these resins are acceptable. Note that when the resin and the mold being the original mold are heated and pushed against each other, it is preferable that the resin has softness capable of forming the fine pattern to be transferred. This is because as described later, when the mold being the original mold is pushed against the resist, the resist is easily deformed corresponding to the fine pattern of the original mold 30, so that the fine pattern can be transferred with high pattern precision by a cooling treatment performed later. Note that the thermosetting resin may also be used as the resin.

After transfer of the fine pattern, a remained layer of the resist on the oxide and nitride chromium layer 3 is removed by ashing using plasma of a gas such as oxygen and ozone, etc., to thereby form a resist pattern corresponding to the desired fine pattern. Then, the sub-master mold 20 for the master mold for imprint is completed through the step descried in embodiment 1.

### Embodiment 3

In the embodiment 2 described above, the silicon wafer is given for example as the substrate of the sub-master mold 20 for thermal imprint. The silicon wafer is opaque to UV-ray, and therefore it is considered to be not necessarily appropriate as the mold for optical imprint. However, even in a case of using the original mold 30 using the silicon wafer, pattern transfer can be suitably performed if irradiation of the UV-ray is performed from the side of the mask blanks (namely the side of the light-transmissive quartz substrate 1) for the sub-master mold 20. In this embodiment, irradiation of the UV-ray from the side of the mask blanks will be described.

This embodiment is similar to embodiment 1 up to a process of forming the hard mask layer and the resist layer 4 (FIGS. 1(a) to (c)). However, the irradiation of the UV-ray is performed from the side of the original mold 30 in embodiment 1, and meanwhile the irradiation of the UV-ray is performed from the side of the light-transmissive quartz substrate 1 being the transferred substrate in this embodiment. Conventionally, when the substrate 1 of the mask blanks is the silicon wafer, considerable time is required for the exposure due to the opaqueness to the UV-ray. However, by using the above method, the time required for the exposure can be considerably shortened. Further, even if the original mold 30 is opaque to the UV-ray, the fine pattern can be transferred with high pattern precision by the exposure from side of the light-transmissive quartz substrate 1.

The sub-master mold 20 is fabricated hereafter, similarly to embodiment 1.

Embodiments of the present invention are given as described above. However, the above-mentioned disclosure content is not limited to the above-mentioned exemplary embodiments, and various modifications can be added by a skilled person, to the embodiments of the present invention based on the disclosure content of this specification, irrespective of whether or not it is clearly described or suggested in this specification.

### EXAMPLES

The present invention will be specifically described next, based on an example. It is a matter of course that the present invention is not limited to the following example.

### Example

In this example, a disc-shaped synthetic quartz substrate (outer diameter: 150 mm, thickness: 0.7 mm) was used as the substrate 1 (FIG. 1(a)). The quartz substrate 1 was introduced to a sputtering device. Then, sputtering was performed by the mixed gas of argon and oxygen, using the chromium target as the sputtering target, followed by baking treatment, to thereby form the oxide and nitride chromium layer 3 with a thickness of 2.5 nm (FIG. 1(b)). Thus, the quartz substrate 1 including the hard mask layer composed of the oxide and nitride chromium layer 3 only, was coated with a ultraviolet ray curing resin layer 4 (PAK-01 by TOYO Gose Co., Ltd.) for optical imprint by spin-coating, to a thickness of 45 nm (FIG. 1(c)).

Next, the original mold 30 provided with a line and space pattern of a cycle structure of line:60 nm and space:30 nm, was placed on the light curing resist layer 4, to thereby perform UV-ray exposure (FIG. 1(d)). After transfer of the fine pattern by the UV-ray exposure (FIG. 1(e)), the remained layer of the resist on the oxide and nitride chromium layer 3 was removed by ashing using plasma of an argon gas, to thereby form a resist pattern corresponding to the desired fine pattern (FIG. 1(f)).

Next, the substrate 1 with the hard mask layer having the resist pattern formed thereon, was introduced to the dry-etching device, and the dry-etching (Cl₂) was performed under the atmosphere not containing oxygen substantially, while introducing Cl₂. Then, the hard mask layer was formed, having the fine pattern composed of the oxide and nitride chromium layer only (FIG. 1(g)).

Subsequently, the gas used for the dry-etching applied to the hard mask layer, was vacuum-exhausted, and thereafter the dry-etching using the fluorine-based gas (CHF₃: Ar=1:9 (flow ratio)) was applied to the quartz substrate 1 in the same dry-etching device. At this time, the quartz substrate 1 was etched, using the hard mask layer as a mask, and as shown in FIG. 1(h), the groove corresponding to the fine pattern was formed on the substrate.

At this time, the etching time was adjusted so that the depth of the groove of the substrate 1 was 60 nm. Specifically, etching was performed for 197 seconds. Here, in order to confirm a sectional shape of the pattern, by breaking the blanks for evaluation fabricated as described above, the sectional face of the pattern was observed by a scanning electron microscope. Then, it was found that the resist pattern had disappeared and the surface of the oxide and nitride chromium layer 3 had been exposed. Although the film thickness of the oxide and nitride chromium layer 3 was decreased to about 2 nm, compared with 2.5 nm before etching, it was confirmed that the width of the groove of the quartz substrate 1 had been almost the same as the width of the fine pattern formed on the hard mask layer composed of the oxide and nitride chromium layer 3 only, and the depth of the groove of the quarts substrate 1 had been uniform.

Then, the resist layer 4 remained even after the previous etching, was removed using a sulfuric acid/hydrogen peroxide mixture composed of concentrated sulfuric acid and a hydrogen peroxide solution (concentrate sulfuric acid:hydrogen peroxide solution=2:1 volume ratio), to thereby obtain the mold 10 before removing the remained hard mask layer for manufacturing the sub-master mold 20 of this example (FIG. 1(h)).

Thereafter, the mold 10 before removing the remained hard mask layer after removing the resist layer 4, was introduced to the wet-etching device. Then, the wet-etching was performed using a mixed solution of a di-ammonium cerium(IV) nitrate solution and perchloric acid. Then, the oxide and nitride chromium layer 3 on the substrate was removed, to thereby fabricate the sub-master mold 20 for imprint of this example (FIG. 1(i)).

<Evaluation>

The sub-master mold 20 for imprint obtained by the example, was observed using the scanning electron microscope. The result thereof is shown in FIG. 3. FIG. 3 is a photograph showing the surface of the sub-master mold for imprint of this example.

In the example, it was found from FIG. 3 that the width of the fine pattern was uniform, and the anisotropic etching was performed, and the fine pattern was formed with high pattern precision.

### DESCRIPTION OF SINGS AND NUMERALS

1 Substrate
3 Oxide and nitride chromium layer (hard mask layer)
4 Fine pattern forming resist layer
10 Mold before removing remained hard mask layer
20 Sub-master mold
30 Original mold
6 Resist layer for mount base structure

1. Mold manufacturing mask blanks, used for manufacturing a mold by transferring a fine pattern by imprint, which is formed on a surface of an original mold, and having a hard mask layer including a chromium compound layer expressed by a chemical formula CrOₓN_{y}C_{z} (x>0) on a substrate.

2. The mold manufacturing mask blanks according to claim 1, wherein a conductive layer is not provided on the chromium compound layer of the hard mask layer.

3. The mold manufacturing mask blanks according to claim 1, wherein the hard mask layer is composed of a chromium oxide layer or an oxide and nitride chromium layer only.

4. The mold manufacturing mask blanks according to claim 1, wherein the substrate is a light-transmissive substrate.

5. The mold manufacturing mask blanks according to claim 1, wherein the substrate is a quartz substrate.

6. The mold manufacturing mask blanks according to claim 1, wherein the substrate is silicon carbide or a silicon wafer.

7. Mask blanks with mold manufacturing resist, wherein a pattern forming resist layer is formed on the hard mask layer in the mold manufacturing mask blanks of claim 1.

8. The mask blanks with mold manufacturing resist according to claim 7, wherein the resist layer is made of a light-curing resin.

9. The mask blanks with mold manufacturing resist according to claim 7, wherein the resist layer is made of thermoplastic resin.

10. The mask blanks with mold manufacturing resist according to claim 7, wherein a fine pattern transferred to the mask blanks by imprint, is formed by providing a groove on a substrate, and a thickness of the hard mask layer is 2 nm or more and 5 nm or less when a depth of the groove is beyond 0 nm and 80 nm or less.

11. A method of manufacturing a mold from an original mold for imprint with a groove provided thereon corresponding to a fine pattern, comprising:
forming a hard mask layer including a chromium compound layer expressed by a chemical formula CrOxNyCz (x>0) on a substrate for the mold, and forming a pattern forming resist layer on the hard mask layer;
transferring a fine pattern of the original mold to the resist layer by optical imprint or thermal imprint; and
applying wet-etching to the hard mask layer, with the resist layer to which the fine pattern is transferred, as a mask.

12. A method of manufacturing a mold from an original mold for imprint provided with a groove corresponding to a fine pattern, comprising:
forming a hard mask layer including a chromium compound layer expressed by a chemical formula CrOₓN_{y}C_{z} (x>0) on a substrate for the mold, and forming a pattern forming resist layer on the hard mask layer;
transferring a fine pattern of the original mold to the resist layer by optical imprint or thermal imprint; and
applying dry-etching to the hard mask using a gas including a chlorine-based gas under an atmosphere not including an oxygen gas substantially, with the resist layer as a mask, to which the fine pattern of the original mold is transferred,
wherein, the atmosphere not including the oxygen gas substantially, is the atmosphere that even if the oxygen gas flows into the atmosphere, a flow amount of the oxygen gas is the amount that allows anisotropic etching to be performed during an etching process, and is the atmosphere in which an oxygen content in the etching device is not zero.

13. The method of claim 12, wherein a chlorine gas is used for the dry-etching.

14. The method of claim 11, wherein a conductive layer is not provided on the chromium compound layer of the hard mask layer.

15. The method of claim 11, wherein the hard mask layer is composed of a chromium oxide layer or an oxide and nitride chromium layer only.

16. The method of claim 11, wherein the substrate is a light-transmissive substrate.

17. The method of claim 11, wherein the substrate is a quartz substrate.

18. The method of claim 11, wherein the resist layer is made of a light-curing resin, and optical imprint is used for transferring the fine pattern to the resist layer.

19. The method of claim 18, wherein when the original mold is formed by a non-light-transmissive substrate, exposure is performed from a side of a transferred substrate for the mold.

20. The method of claim 11, wherein the substrate is made of silicon carbide or a silicon wafer.

21. The method of claim 11, wherein the resist layer is made of thermoplastic resin, and thermal imprint is used for transferring the fine pattern to the resist layer.

22. The method of claim 11, wherein the fine pattern transferred to the mask blanks by imprint, is formed by forming a groove on the substrate, and when a depth of the groove is beyond 0 nm and 80 nm or less, a thickness of the hard mask layer is 2 nm or more and 5 nm or less.
